(19) United States
(12) Patent Application Publication
(10) Pub. No.: US 2003/0170387 A1
(43) Pub. Date: Sep. 11, 2003

(54) Collective method for flush filling of through holes in a substrate

(76) Inventors: Francis Bourrieres, Montauban (FR); Clement Kaiser, Montauban (FR)

Correspondence Address: Walter J Steinkraus, Vidas Arrett & Steinkraus, 6109 Blue Circle Drive, Suite 2000, Minnetonka, MN, 55343-9185, US

(21) Appl. No.: 10/343,941

(22) PCT Filed: Jul. 25, 2001
(86) PCT No.: PCT/FR01/02422

(30) Foreign Application Priority Data
Aug. 28, 2000 (FR) 00/10984

(51) Int. Cl. B05D 7/22; B05D 3/12

(52) U.S. Cl. 427/230; 427/355

(57) ABSTRACT

This invention proposes a device for the mass filling of through holes in a substrate with a resin or any insulating or conducting product.

Process for mass, flush filling of through holes (2) in a substrate (1) with a product (3) utilizing an open scraper (7) or a closed device (4) in lateral movement relative to the primary face of the substrate to press product (3) into said holes, obtaining a flush fill on the first face and an overflow on the second face, characterized by the fact that the scraping device (8) is composed of two flexible edges (9) set in opposition and at an angle α in relation to the substrate greater than or equal to 90° in the scraping zone forming a container for the sheared product, said scraping device moving simultaneously with the scraper (7) or the closed device (4), with the transfer occurring in a zone situated between the two edges (9) of the scraping device.

This invention seeks to propose a process for mass filling without bubbles of through holes in a substrate with a product that is flush on both faces of the substrate. This description refers in particular to the filling of transverse holes in printed circuits.

Completely filling through holes perfectly flush with a surface with a product without bubbles poses problems. In truth, the utilization of existing transfer systems, such as those used with serigraphy machines, results in either incomplete filling or excess filling that results in a surplus of product at the mouth of the opening. Patent FR96.12671 by this same inventor describes a direct-transfer device that allows better control over the quantity of product injected into through holes by adjusting the transfer pressure and time of contact. However, control is not sufficient to allow filling of holes such that the product is flush with the emerging face of the substrate. This is especially true if the holes are of different diameters, since in this instance the resistance to product flow is not constant, resulting in a quantity of product injected into the hole that increases with its diameter.

Another patent application by this same inventor, FR00.09785, describes a procedure for filling blind holes in a substrate. It also describes a method for filling through holes, but prior to their filling the emerging face must be covered by a film that is rolled across the substrate. This film is removed after filling. Although this process is extremely effective and attractive, it presents the disadvantage of requiring the installation and removal of the blocking film. In addition, removal of the film while the product is still in a wet state will cause a certain amount of the product to seep out of the hole, which is incompatible with filling that must be flush with the emerging face of the substrate.

This invention seeks to propose an alternate method for the mass, flush filling of through holes without bubbles that is free from the disadvantages of past devices.

The process for the mass, flush filling of through holes in a substrate utilized by this invention is essentially characterized by lateral movement relative to the primary face of the substrate by a device for transferring the product that forces the aforementioned product into the through holes such that the product overflows onto the second face of the substrate, and then scrapes the excess product that has spread on the primary face. Next, after this stage of the filling, a scraping device moving with a lateral motion relative to the second face of the substrate shears off the excess product and levels the aforementioned product with the holes so it is flush with the second face of the substrate, without causing an increase of product on the opposite face thanks to an angle greater than 90° between the edge of the scraper and the substrate.

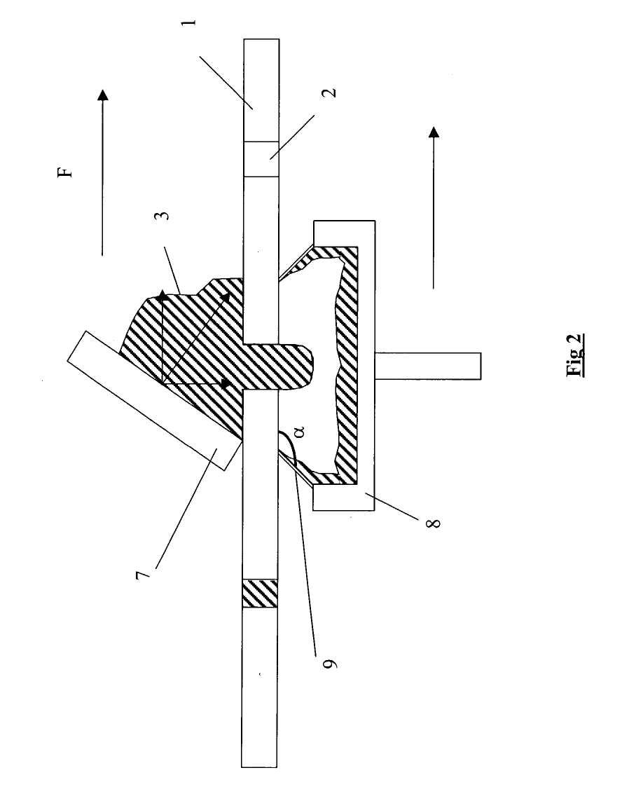

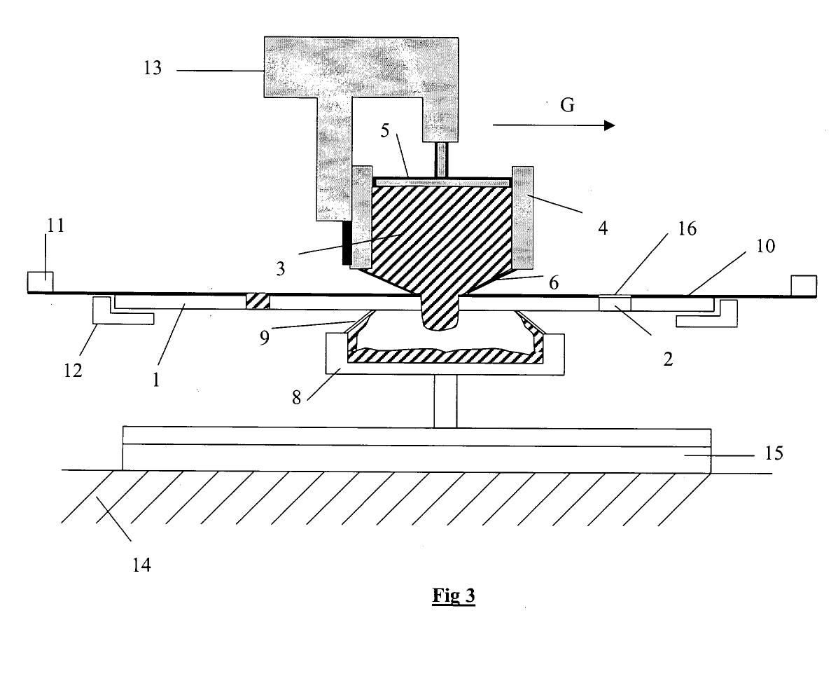

U.S. Pat. No. 4,728,568 A does not consist of a process for filling, but rather a process for blocking in order to accomplish filling. To solve the blocking problem, it uses water-soluble adhesive materials. As for the filling process itself, it uses standard filling methods. The filling methods described in FIGS. 2, 3, and 4 of the patent do not allow the precise result required by the invention, namely a perfect leveling of the product filling the holes and no presence of bubbles in the hole interior. In FIG. 2, the circuit passes between rollers 4 and 4′, and then two opposed scrapers 6 and 6′ remove the surplus product. This technique has a major disadvantage in that it inserts air bubbles into the filling material because upper roller 4 blocks one of the openings, while the lower roller ensures filling through the other opening. Filling without bubbles is one of the problems identified and solved in this proposed invention. FIG. 3 utilizes the classic technology of filling by transfer with a scraper. This process neither seeks nor allows the flush filling of a product; this operation is performed by abrasion after hardening. FIG. 4 shows a filling method utilizing one scraper 14 above the transfer and a scraper 14′ below to remove excess product. This process has a drawback, namely that the first scraper 14 is ahead in relation to 14′ such that it pushes the product through to the lower face, while the inclination of 14′ at an angle less than 90° generates a transfer force that tends to push the product back into the interior of the hole and causes it to emerge on the superior face, which does now allow flush filling. The solution proposed in the present invention seeks to neutralize the transfer force caused by the lower scraper that tends to push the product upward.

U.S. Pat. No. 5,268,194 A offers a system for injecting product into the holes to be filled with a lower and upper scraper to scrape the excess. As has already been stated above, the major drawback of such a process is that the angle of the scrape is less than 90° in its active part, thus causing a transfer force that tends to push the product back and cause it to emerge on the opposite face, which prevents flush filling of the product on at least one of the two faces. Another disadvantage of this method of scraping using a scraper with an angle less than 90° is that is spreads the product across the entire surface, whereas angle α greater than 90° removes the product by shearing, thereby detaching it to be collected in the container. The fact that the product is not spread is also very important in that it contributes to flush filling. The patent thus does not answer the problem that needs to be solved.

Patent Matsushita Electric Ind JP 032 40292 seeks to fill holes and spread precisely over the entire surface a resist ink for etching by successive passage between two rollers and two opposed scrapers. In this invention, the purpose of the scrapers is to spread a fine film of product over the entire surface and not remove it by detaching it from the surface by shearing. In this case, its goals are the complete opposite of the problem that the inventor seeks to resolve (spreading the product as opposed to its removal), and the means utilized are also different because, as has already been explained, the scrapers utilized here are placed at an angle less than 90°.

Another characteristic of the invention is that a shielding screen with openings aligned with the through holes can be inserted between the primary face of the substrate and the transfer device. In this instance, the transfer device will move along the surface of the screen, and the product will not contaminate the primary face of the substrate. The shielding screen can also have a determined thickness to control the extra thickness of product in relation to the primary face. For example, the screen can be very thin if no extra thickness of product is desired.

Another characteristic of the invention's process and resulting device is that it can be adapted for a commercial serigraphy machine. As an example, this process could be adapted for DEK or MPM-type machines that are used in the field of electronics manufacturing.

Another characteristic of the invention is that its transfer device can be composed of an inclined serigraphy scraper, or preferably by a closed direct transfer device such as the PROFLOW marketed by DEK or the RHEOPUMP marketed by MPM.

Another characteristic of the invention is that the scraper is composed of at least one flexible edge that is set at an angle α greater than 90° degrees in relation to the substrate in the scraping zone and a container that allows recovery of the sheared product. Preferably, the scraper is a closed device with two flexible edges as described above and arranged opposite one another, such that the scraper can function in two directions.

Other characteristics and advantages of the present invention will appear from the non-limiting examples of the implementation of the invention illustrated by the figures.

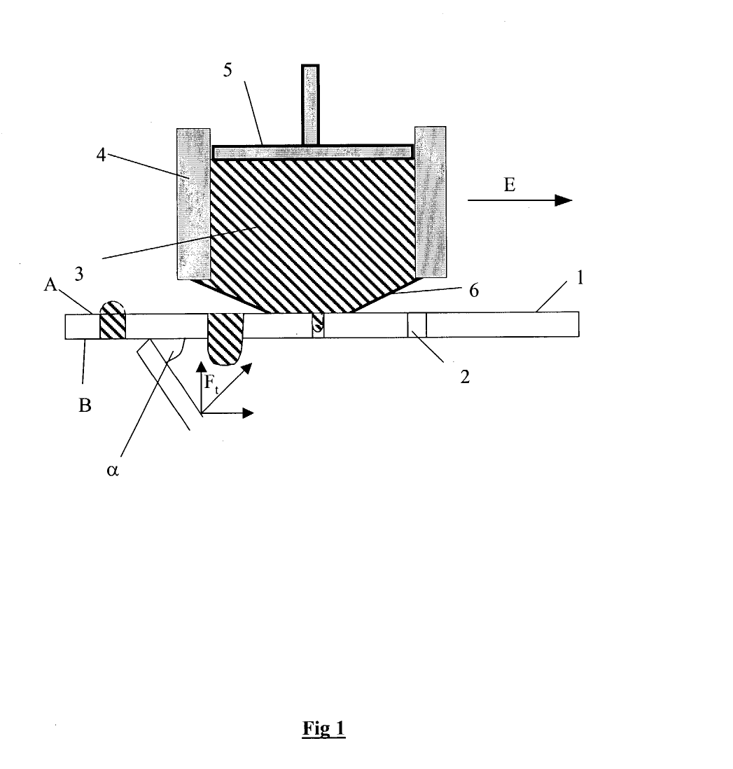

FIG. 1 illustrates in cross-section the filling operation as conducted in the previous standard manner.

FIG. 2 illustrates in cross-section a device for mass filling utilizing the present invention.

FIG. 3 illustrates in cross-section a device for mass filling utilizing the present invention mounted on a serigraphy machine.

In FIG. 1, a system of direct transfer (4) is represented equipped with edges (6) and a piston (5) that applies transfer pressure on the product (3) conjointly with the lateral movement of the direct transfer system in direction (E). As the device progresses, the product (3) is forced into the openings (2) of substrate (1). A scraper (9) forming an angle α less than 90 causes a flush surface on face (B) but generates transfer force Fₜ that pushes the product through to the opposing face (A), thereby eliminating the flush surface on said face.

FIG. 2 illustrates in cross-section a device utilizing the present invention.

In this instance, the product (3) is forced into openings (2) in the substrate (1) by the bias of the transfer device, which in the present instance is composed of an inclined scraper (7) that is moved in direction (F). The transfer force exerted by the device (7) on the product (3) is conveyed through the hole so that the product (3) overflows onto the lower face of the substrate (1).

Simultaneously, scraping device (8) situated opposite the transfer device (7) in relation to the substrate is displaced in direction (F). The scraping device (8) is in contact with the lower face of the substrate by means of flexible edges (9). As the scraping device advances, product that extends beyond the lower face of the substrate is sheared off and recovered in a container (8). The relative position between the transfer device and the scraping device (8) is such that transfer occurs in a zone situated between the two edges (9) of the scraping device. So that excess product is sheared without being spread out and without being pushed through to the opposite face, the thin and flexible edges (9) are set at an angle α in the scraping zone that is greater than or equal to 90°. Thus the excess product is sheared, detached, and collected in container (8), from which it can possibly be recovered and reused. As an example, edges with a thickness of 100 to 500 microns and an angle α of 150° gave very good results.

FIG. 3 illustrates another implementation of the present invention. In this instance, a device utilizing the present invention has been adapted to an existing serigraphy machine. The transfer device (4) containing the product (3) is in contact with the screen (10) by means of edges (6). The screen (10) is aligned with the substrate so that its holes (16) are in line with the holes (2) in the substrate (1). Product contained in the transfer device is placed under pressure by means of a piston (5). The substrate (1) rests on a conveyor (12) and is in contact with the scraping device (8) by means of edges (9). The scraping device (8) can be moved by a lateral movement system (15) of any known type that is attached to the table of the serigraphy machine (14). When transfer device (4) is set in motion in direction (G) by frame (13), the product is transferred into the openings in the screen and substrate such that the product overflows the lower face of the substrate. The scraping device (8) is displaced in direction (G) at the same speed as the transfer device (4), and the relative position between the two is such that the transfer zone delimited by edges (6) is always situated between the flexible edges (9) of the scraping device.

When scraping is finished, the transfer device (4) remains in contact with the screen (10), while the scraping device (8) is away from the substrate (1) due to the slope of the table (14). The substrate itself is separated from the screen, to be removed and replaced by a substrate that needs to be filled. Due to the symmetry of the device, it can function in direction (G) as well as in the opposite direction, which increases productivity attained with such a device.

Another characteristic of a device utilizing the invention is that it can be used, depending on applications and the nature of the product to be filled, to work in positions other than horizontal. Positions ranging from horizontal to 90° vertical are possible.

Another characteristic of the present invention is that, if necessary, a very thin shielding screen can be placed on the lower face to avoid staining or contaminating the substrate while shearing the transferred product. This screen has openings aligned with the through holes to be filled.

Other applications are possible within the scope of the present invention. For example, the present invention can be used to saturate fabrics, meshes, or other porous items using more or less viscous products.

1) process for mass, flush filling of through holes (2) in a substrate (1) with a product (3), utilizing an open scraper (7) or a closed device (4) in lateral movement relative to the primary face of the substrate to press product (3) into said holes, obtaining a flush fill on the first face and an overflow on the second face, characterized in that after the filling stage a flexible edge (9) set at angle α greater than or equal to 90° in lateral movement relative to the second face shears and detaches the overflow product:

2) Process for mass, flush filling of through holes (2) in a substrate (1) with a product (3) utilizing an open scraper (7) or a closed device (4) in lateral movement relative to the primary face of the substrate to press product (3) into said holes, obtaining a flush fill on the first face and an overflow on the second face, similar to claim 1, characterized by the fact that it utilizes a shielding screen (10) placed between the primary face of the substrate (1) and the transfer device (4) or (7) with openings (16) aligned with the through holes (2).

3) Process for mass, flush filling of through holes (2) in a substrate (1) with a product (3) utilizing an open scraper (7) or a closed device (4) in lateral movement relative to the primary face of the substrate to press product (3) into said holes, obtaining a flush fill on the first face and an overflow on the second face, similar to claims 1 and 2, taken together or separately, characterized by the fact that it can be used on a serigraphy machine.

4) Process for mass, flush filling of through holes (2) in a substrate (1) with a product (3) utilizing an open scraper (7) or a closed device (4) in lateral movement relative to the primary face of the substrate to press product (3) into said holes, obtaining a flush fill on the first face and an overflow on the second face, similar to claims 1 to 3, characterized by the fact that the scraping device (8) is composed of two flexible edges (9) set in opposition and at an angle α in relation to the substrate greater than or equal to 90° in the scraping zone forming a container for the sheared product, said scraping device moving simultaneously with the scraper (7) or the closed device (4), with the transfer occurring in a zone situated between the two edges (9) of the scraping device (8).
